(19) United States
(12) Patent Application Publication
(10) Pub. No.: US 2012/0019709 A1
(43) Pub. Date: Jan. 26, 2012

(54) ASSISTING FOCUSING METHOD USING MULTIPLE FACE BLOCKS

(75) Inventors: Chih Pin Yen, Taipei County (TW); Chia Lun Tsai, Changhua County (TW); Li Wen Kuo, Taichung County (TW)

(73) Assignee: ALTEK CORPORATION, Hsinchu (TW)

(21) Appl. No.: 12/840,605

(22) Filed: Jul. 21, 2010

(51) Int. Cl. H04N 5/232

(52) U.S. Cl. 348/349; 348/E05.042

(57) ABSTRACT

A method using multiple face blocks for assisting focusing is applicable in an image capture device. The assisting focusing method includes the following steps. A focusing image is captured individually at a focusing distance. The focusing image has a plurality of face blocks. The face blocks in the focusing image are detected. Clarities of the face blocks in the focusing image are calculated with the image capture device. A face focal length corresponding to the face block is calculated according to the clarity corresponding to the face block. A target focal length is obtained according to the face focal length.

### BACKGROUND OF THE INVENTION

1. Field of Invention

The present invention relates to an assisting focusing method, and more particularly to an assisting focusing method using multiple face blocks.

2. Related Art

When an image is photographed, a focal length needs to be set to a photographed object correctly to obtain a clear picture. Nowadays, an auto focusing (AF) function is built in a common image capture device such as a digital camera. The AF may be basically categorized into active auto focus and passive auto focus.

Regarding the technology of active auto focus, a pattern of light is projected to a photographed object with a group of infrared emitters or laser emitters and corresponding receivers, a distance between the camera and the photographed object is then calculated through a method such as triangulation, and the distance is the focal length. For the active auto focus, light emitters and receivers need to be additionally set inside the camera, thereby causing a problem of high cost.

Regarding the passive auto focus, before formal photographing, the image capture device moves a lens to focus to a plurality of focusing distances. The focusing distance is in a range from a micro distance closest to the image capture device to an infinite distance. The image capture device captures an image at the focusing distance and analyzes clarities of the obtained images to determine a focal length. The passive auto focus mode only needs to use an image sensor and an operation unit included in the camera itself, so that the fabrication cost may be reduced.

However, in recent years, the number of users that use image capture devices such as a digital camera to photograph images is greatly increased. Except for photography professionals, more and more common users use digital cameras for photographing. Generally speaking, an image photographed by a common user often has problems such as an incorrect focal length as the photography techniques of the common user are not as good as that of the professional ones. However, when a picture is photographed, a person image is usually an important part in the picture. For a conventional auto focus mode, a problem that a background or other objects instead of persons might be determined as photographing subjects but the persons that should be the photographing emphasis are defocused. Especially, when the photographed image is a human face image, photographing defects that occur on the face seems even worse.

Therefore, a heretofore unaddressed need exists in the art to address the aforementioned deficiencies and inadequacies.

### SUMMARY OF THE INVENTION

In one aspect, the present invention relates to an assisting focusing method using multiple face blocks, which is applicable in an image capture device. In one embodiment, the assisting focusing method using multiple face blocks comprises the following steps. Focusing images are captured individually at a plurality of focusing distances. Each focusing image has a plurality of face blocks. The face blocks in the focusing image are detected. A clarity (or referred to as a contrast value) of each face block in each focusing image is calculated with the image capture device. According to the clarity corresponding to each face block, a face focal length corresponding to each face block is calculated. A target focal length is obtained according to the face focal length.

The image capture device may calculate the clarity of each face block at the focusing distances in single auto focusing (AF) scanning When the face focal length is calculated, the face focal length may be calculated through a quadratic polynomial approximation method on the clarity.

The step of obtaining the target focal length according to the face focal length may comprise the step of using a median, a mode, or a mean of all face focal lengths as the target focal length.

In addition, in an embodiment of the present invention, the step of obtaining the target focal length according to the face focal length may also comprise the step of using the face focal length of the face block corresponding to a subject face as the target focal length according to the subject face of the image capture device. In this embodiment, the subject face is obtained according to a predetermined specific rule in the image capture device. For example, the subject face may be one of the face blocks that is the largest or closest to a center among all face blocks.

In an embodiment of the present invention, the step of obtaining the target focal length according to the face focal length comprises the following steps. Face blocks are displayed. A selection instruction is received. The selection instruction designates one of the face blocks as the subject face. The face focal length of the subject face serves as a target focal length. In this embodiment, the subject face may be selected by a user.

In an embodiment of the present invention, the step of obtaining the target focal length according to the face focal length may still comprise the following steps. A depth of field (DOF) range of each face block is calculated according to the face focal length. In the DOF ranges, a face focal length corresponding to the DOF range that covers the most face focal lengths is used as the target focal length.

The image capture device may comprise a micro processor unit for calculating the clarity of each face block of each focusing image.

In conclusion, in the assisting focusing method using multiple face blocks according to the present invention, the face focal lengths corresponding to the face blocks are calculated according to the plurality of face blocks, and the target focal length is obtained according to the face focal lengths. The assisting focusing method using multiple face blocks also calculates the target focal length with reference to the face focal lengths, so as to obtain the target focal length that enables clear imaging of the photographed persons.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a schematic block diagram of an image capture device according to an embodiment of the present invention;

FIG. 2 is a flow chart of an assisting focusing method using multiple face blocks according to an embodiment of the present invention;

FIG. 3 is a schematic view of a focusing distance according to an embodiment of the present invention;

FIG. 4 is a schematic view of a face block according to an embodiment of the present invention;

FIG. 5 is a schematic view of a face focal length according to an embodiment of the present invention; and

FIG. 6 is a schematic view of a DOF range according to an embodiment of the present invention.

### DETAILED DESCRIPTION OF THE INVENTION

The detailed features and advantages of the present invention are described below in great detail through the following embodiments, the content of the detailed description is sufficient for persons skilled in the art to understand the technical content of the present invention and to implement the present invention there accordingly. Based upon the content of the specification, the claims, and the drawings, persons skilled in the art may easily understand the relevant objectives and advantages of the present invention.

The present invention relates to an assisting focusing method using multiple face blocks applicable in an image capture device.

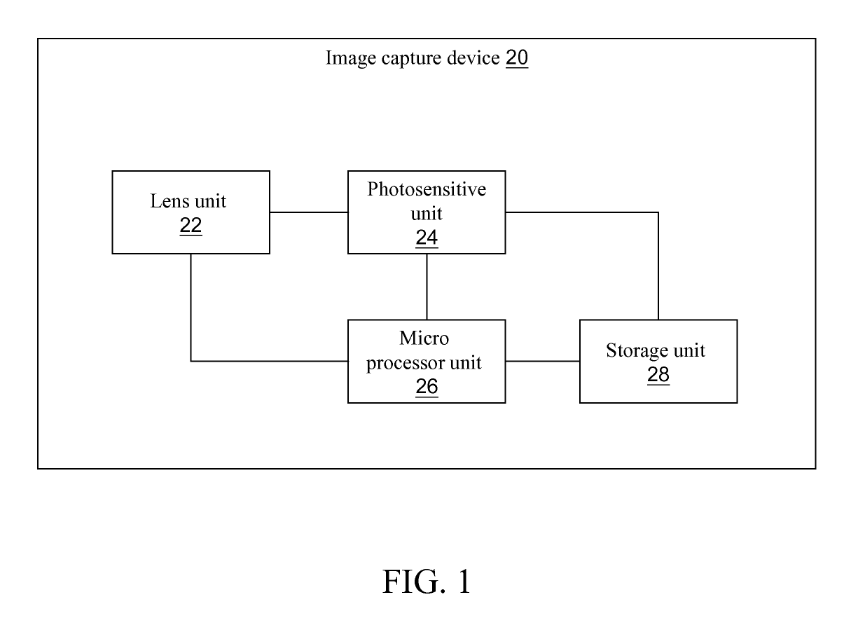

FIG. 1 is a schematic block diagram of an image capture device according to an embodiment of the present invention.

The image capture device 20 may be, for example, a digital camera, a cell phone having a photographing function, a video camera, or a webcam. The image capture device 20 may comprise a lens unit 22, a photosensitive unit 24, a micro processor unit 26, and a storage unit 28. When an image is captured, the image capture device 20 focuses the lens unit 22 at a focusing distance. The micro processor unit 26 controls the lens unit 22 to a focusing position corresponding to the focusing distance and stores an image obtained with the lens unit 22 and the photosensitive unit 24 into the storage unit 28.

Specifically, the focusing position may also be referred to as a focusing length, which means a distance from an optical center point of the lens unit 22 to the photosensitive unit 24 and is determined by a lens designer during design. A longer focusing length makes a smaller viewing angle, and a shorter focusing length makes a larger viewing angle. The lens unit 22 having a zoom function may adjust positions of lenses in the lens unit 22 before photographing, so as to change the focusing length. The focusing distance means a distance from an optical center point of the lens unit 22 to the photographed object or photographed person, which may be designated through an auto focusing (AF) function of the camera.

The image capture device 20 is near “wide” when the focusing length is short and the image capture device 20 may capture an image having a large area. On the contrary, the image capture device 20 is near “tele” when the focusing length is long; in a visual effect it looks like scenery images at a long distance away are drawn nearer to the image capture device 20, thereby realizing an effect of enlarging the scenery.

The image capture device 20 may capture an image through the AF function, and the lens unit 22 may move to different focusing positions one by one for auto focusing.

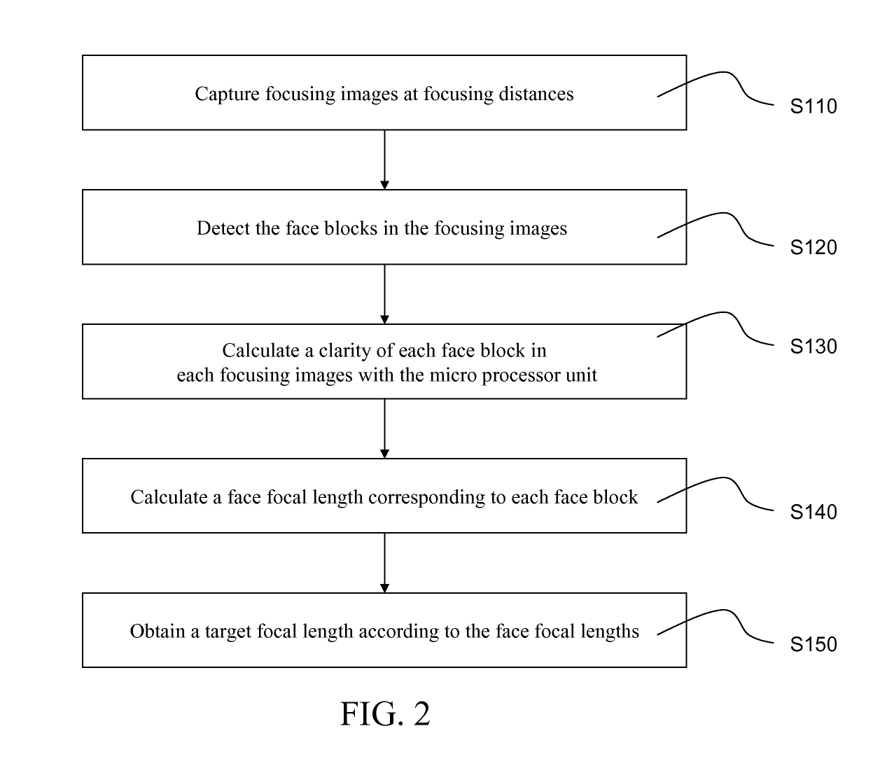

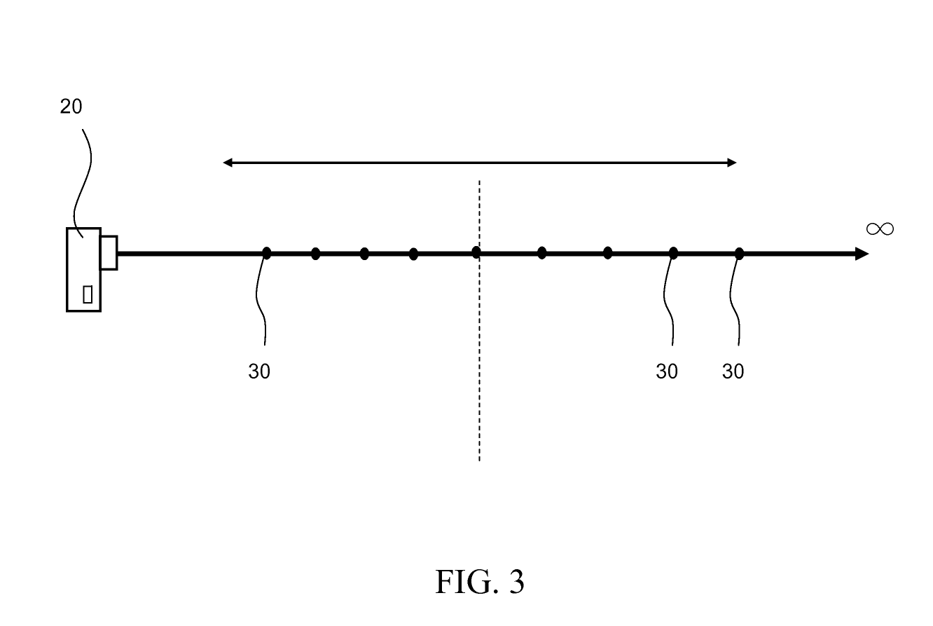

Referring to FIGS. 2 and 3, according to an embodiment of the present invention, FIG. 2 is a flow chart of an assisting focusing method using multiple face blocks and FIG. 3 is a schematic view of a focusing distance.

First, the image capture device 20 captures focusing images individually at the plurality of different focusing distances 30 (Step S110). Each focusing image has a plurality of face blocks. The face block means an image of a face part in the focusing image after a human face is captured into an focusing image.

In an range between the image capture device 20 and an infinite distance, the plurality of focusing distances 30 may be focused in sequence and focusing images corresponding to the focusing distances 30 are captured. In other words, the image capture device 20 moves the lens unit 22 to the plurality of focusing positions to capture the focusing images.

After the focusing images are captured, the micro processor unit 26 of the image capture device 20 performs a face detect procedure, so as to detect the face blocks in the focusing images (Step S120). The micro processor unit 26 may detect the face blocks in cooperation with a dynamic tracking procedure, so as to determine whether the face blocks that appear in different focusing images correspond to the same photographed person.

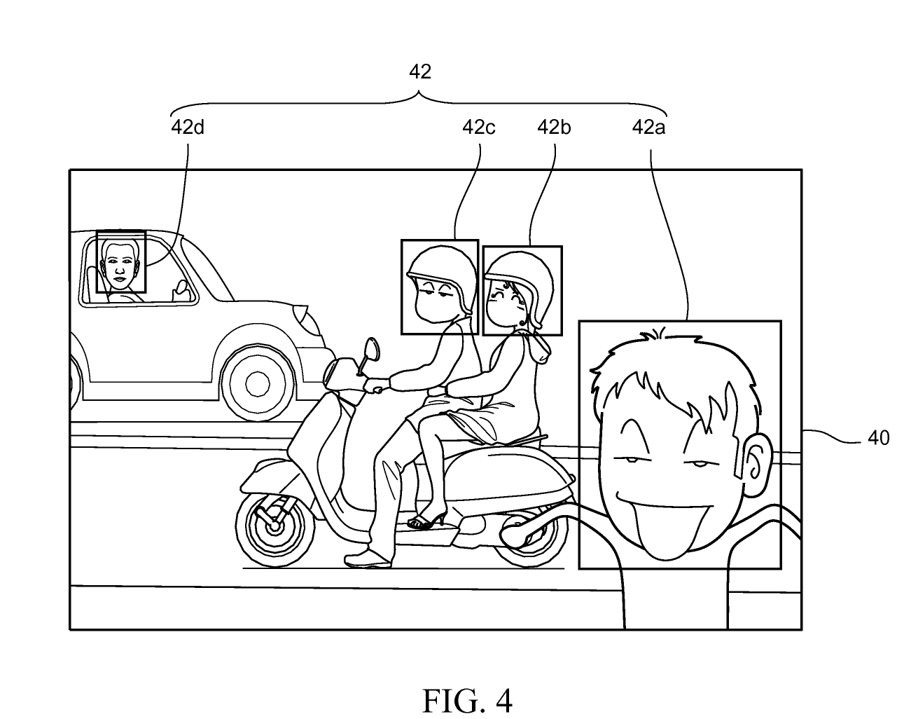

FIG. 4 is a schematic view of a face block according to an embodiment of the present invention.

The focusing image 40 has face blocks 42a, 42b, 42c, and 42d. When the image is captured, distances between the image capture device 20 and persons corresponding to the face blocks 42 may be different. In addition, although in the specification and figures a block is used to represent the face block 42, the face block 42 may also be a partial image that forms an elliptic or an irregular shape in the focusing image 40. According to the present invention, the executed face detection procedure and the shape of the detected face block 42 are not limited.

After the face blocks 42 in the focusing images 40 are obtained, a clarity (or referred to as a contrast value) of each face block 42 in each focusing image 40 is calculated with the micro processor unit 26 in the image capture device 20 (Step S130). That is to say, the clarity of each face block 42 in each focusing image 40 captured at the different focusing distance 30 is calculated.

According to the present invention, the image capture device 20 may calculate the clarities of all face blocks 42 at the focusing distances 30 in a single auto focus scanning In the single auto focus scanning, the focusing images 40 are usually captured in sequence from the wide closest to the image capture device 20 to the tele that is at an infinite distance, or the focusing images 40 are captured in sequence from the tele to the wide on the contrary.

Steps S120 and S130 may be performed separately after the focusing image 40 is captured or may also be performed at a time after all focusing images 40 are captured. Specifically, the micro processor unit 26 may detect the face blocks 42 in the focusing image 40 and calculate the clarifies of the face blocks 42 right away after the focusing image 40. In such a manner, the micro processor unit 26 may obtain different focusing images 40 one by one and calculate the clarities of the face blocks 42 in the focusing image 40 one by one.

Relatively, if capacity of the storage unit 28 of the image capture device 20 is large enough, the micro processor unit 26 may also perform Steps S120 and S130 after a plurality of or even all the focusing images 40 are obtained.

Next, the micro processor unit 26 calculates a face focal length corresponding to each face block 42 according to the clarity corresponding to each face block 42 (Step S140). Preferably, the micro processor unit 26 may calculate the face focal lengths through a quadratic polynomial approximation method on the clarifies. The quadratic polynomial approximation method may also be referred to as a quadratic polynomial curve-fitting method. In the method, the focusing distance 30 and the corresponding clarity may serve as an X axis and a Y axis for point tracing, and a clarity curve is obtained. The clarity curve represents clarifies of face blocks 42 corresponding to the same photographed person in different focusing images 40. In other words, the clarity curve represents changes of the clarities of the face blocks 42 corresponding to different focusing distances 30 when images of the same photographed person are captured at different focusing distances 30.

After the quadratic polynomial method is performed according to the clarifies, that is, after the quadratic polynomial curve fitting is performed according to the clarity curve, a peak of the clarity curve may be obtained. The peak of the clarity curve represents the highest clarity that the corresponding face block 42 has, and the focusing distance 30 corresponding to the peak is used as the face focal length of the face block 42.

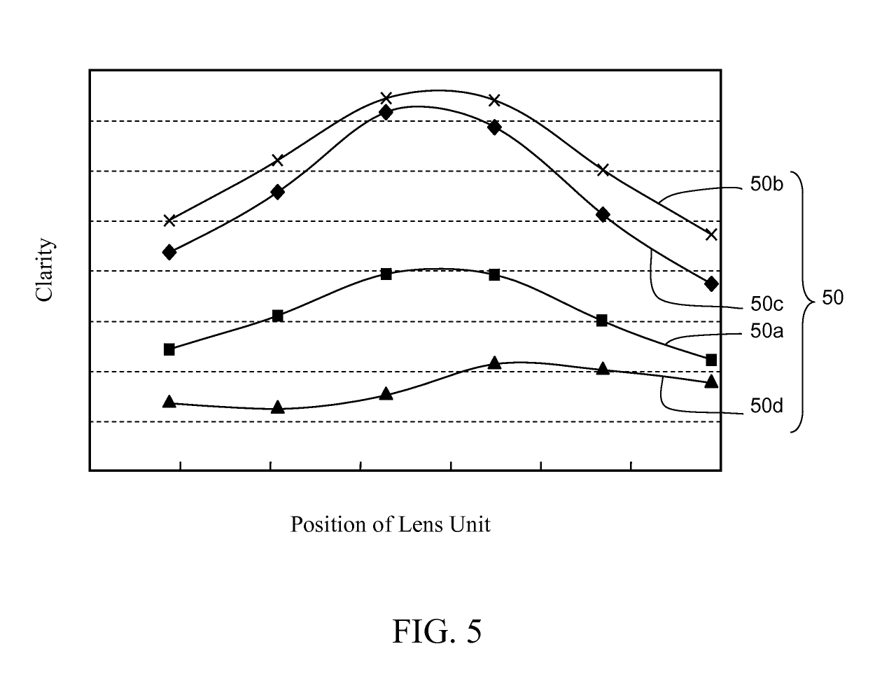

FIG. 5 is a schematic view of a face focal length according to an embodiment of the present invention. Clarity curves 50a, 50b, 50c, and 50d in FIG. 5 correspond to the face blocks 42a, 42b, 42c, and 42d in FIG. 4, respectively. The focusing distances 30 corresponding to peaks of the clarity curves 50 corresponding to all face blocks 42, that is to say, the face focal lengths corresponding to all face blocks 42 may be different from one another.

Next, the image capture device 20 obtains a target focal length according to the face focal lengths (Step S150). The target focal length is a focal length that is most suitable for the face blocks 42 found through the assisting focusing method using multiple face blocks, that is, a focal length used by the user to photograph the image.

The step of obtaining the target focal length according to the face focal length may comprise using a median, a mode or a mean of all face focal lengths as a target focal length. That is to say, in Step S150, a median, a mode or a mean of all the face focal lengths may be acquired to serve as the target focal length. In addition, in order to simplify the operation, the face focal length or the focusing distance 30 closest to the median, the mode, or the mean may also be acquired to serve as the target focal length.

In an embodiment of the present invention, the step of obtaining the target focal length according to the face focal length may also comprise using the face focal length of the face block 42 corresponding to a subject face as the target focal length, according to the subject face of the image capture device 20. The subject face may be obtained according to a predetermined specific rule in the image capture device 20. That is to say, the image capture device 20 may determine which face block 42 is the subject face automatically according to a rule built in the image capture device 20. For example, the subject face may be the largest face block 42, the face block 42 closest to a center of the focusing image 40, or the face block 42 having the shortest corresponding face focal length among all the face blocks 42.

According to a further embodiment of the present invention, the step of obtaining the target focal length according to the face focal length may comprise the following steps. Face blocks 42 are displayed. A selection instruction is received. The selection instruction designates one of the face blocks 42 as the subject face. The face focal length of the subject face serves as the target focal length. Specifically, the face block 42 may be displayed to the user with a display unit (not shown) of the image capture device 20 and the user then selects the subject face. For example, all face blocks 42 may be marked in the focusing image 40 captured finally to be displayed to the user; or the plurality of focusing images 40 corresponding to all face focal lengths are displayed to the user.

In addition, according to an embodiment of the present invention, the step of obtaining the target focal length according to the face focal length may still comprise the following steps. According to face focal lengths, a depth of field (DOF) range of each face block 42 is calculated. In the DOF ranges, a face focal length corresponding to the DOF range that covers the most face focal lengths is used as the target focal length.

The DOF range is also referred to as the DOF, which is a distance range that an image may be clearly formed in a space. Basically, the lens unit 22 can only focus the light to one point at a certain distance, and images far away from the point gradually become blurred. However, within a certain specific distance, a degree that the image is blurred is not perceptible for a human eye. This part of distance is called the DOF(range). The DOF range changes according to an aperture value of the lens unit 22 and the focusing distance 30.

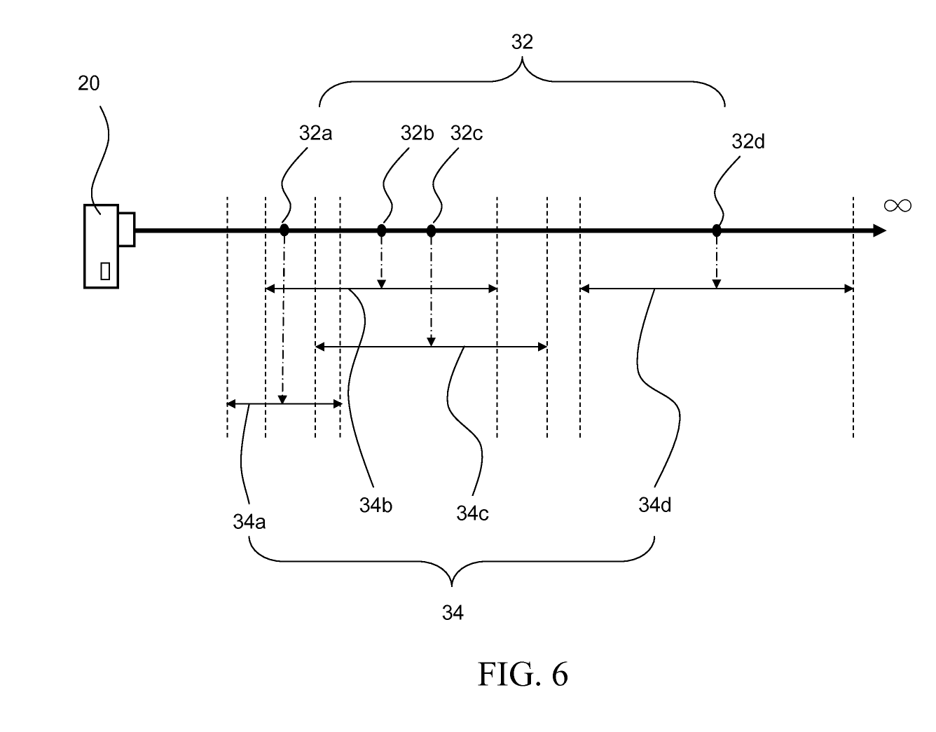

FIG. 6 is a schematic view of a DOF range according to an embodiment of the present invention. The face focal lengths 32 corresponding to each face block 42 have their own respective DOF ranges 34. The face focal lengths 32a, 32b, 32c, and 32d correspond to DOF ranges 34a, 34b, 34c, and 34d, respectively. In Step S150, the image capture device 20 may use the face focal length 32 corresponding to the DOF range 34 that covers the most face focal lengths 32 as the target focal length. In such a manner, if the image is captured according to the target focal length, an image that has the most clear face blocks 42 may be obtained.

It should be noted that in the assisting focusing method using multiple face blocks according to the present invention, all face blocks 42 in the focusing image 40 may not be used. In order to enable a good use experience for the user, some of the face blocks 42 in the focusing image 40 may be used, only according to operation capability of the micro processor unit 26 or capacity of the storage unit 28. For example, when the number of the face blocks 42 in the focusing image 40 is too large, N face blocks 42 that have the largest range or closest to a center of the image may be selected for the assisting focusing method using multiple face blocks. The N is greater than or equal to 2. In such a manner, the time needed for focusing may be effectively decreased.

In conclusion, the assisting focusing method using multiple face blocks according to the present invention calculates the face focal lengths corresponding to the plurality of face blocks according to the face blocks in the focusing image. As additional hardware such as a light emitter and a light receiver does not need to be set within the image capture device, the fabrication cost is low. Moreover, the assisting focusing method using multiple face blocks calculates the target focal length with reference to the face focal length that may enable the face blocks to present the clearest image. Therefore, a face of a suitable photographed person may be focused, so as to obtain a clear image of the photographed person serving as the photographing emphasis.

What is claimed is:

1. An assisting focusing method using multiple face blocks, applicable in an image capture device, comprising:
capturing focusing images individually at a plurality of focusing distances, wherein each focusing image has a plurality of face blocks;
detecting the face blocks in the focusing images;
calculating a clarity of each face block of each focusing image with the image capture device;
calculating a face focal length corresponding to each face block according to the clarity corresponding to each face block; and
obtaining a target focal length according to the face focal lengths.

2. The assisting focusing method using the multiple face blocks according to claim 1, wherein the face focal lengths are calculated through a quadratic polynomial approximation method on the clarities.

3. The assisting focusing method using the multiple face blocks according to claim 1, wherein the step of obtaining a target focal length according to the face focal lengths comprises:
using a median of the face focal lengths as the target focal length.

4. The assisting focusing method using the multiple face blocks according to claim 1, wherein the step of obtaining a target focal length according to the face focal lengths further comprises:
using a mode of the face focal lengths as the target focal length.

5. The assisting focusing method using the multiple face blocks according to claim 1, wherein the step of obtaining a target focal length according to the face focal lengths further comprises:
using a mean of the face focal lengths as the target focal length.

6. The assisting focusing method using the multiple face blocks according to claim 1, wherein the step of obtaining a target focal length according to the face focal lengths further comprises:
according to a subject face of the image capture device, using the face focal length of the face block corresponding to the subject face as the target focal length.

7. The assisting focusing method using the multiple face blocks according to claim 1, wherein the step of obtaining a target focal length according to the face focal lengths further comprises:
displaying the face blocks;
receiving a selection instruction, wherein the selection instruction designates one of the face blocks as a subject face; and
using the face focal length of the subject face as the target focal length.

8. The assisting focusing method using the multiple face blocks according to claim 1, wherein the step of obtaining a target focal length according to the face focal lengths further comprises:
calculating a depth of field (DOF) range of each face block according to the face focal lengths; and
among the DOF ranges, using the face focal length corresponding to the DOF range that covers the most face focal lengths as the target focal length.

9. The assisting focusing method using the multiple face blocks according to claim 1, wherein the image capture device calculates the clarity of each face block at the focusing distances in a single auto focusing (AF) scanning

10. The assisting focusing method using the multiple face blocks according to claim 1, wherein the image capture device comprises a micro processor unit for calculating the clarity of each face block of each focusing image.
